(19) United States
(12) Patent Application Publication
(10) Pub. No.: US 2002/0192834 A1
(43) Pub. Date: Dec. 19, 2002

(54) Analysis of caffeine

(76) Inventors: Bruce J. Sand, Oak Park, CA (US); Lee Kudrow, Tarzana, CA (US); Ali Zendedel Haghighi, Fremont, CA (US)

Correspondence Address: Colin P. Abrahams, Suite 400, 5850 Canoga Avenue, Woodland Hills, CA, 91367, US

(21) Appl. No.: 10/104,147

(22) Filed: Mar. 22, 2002

Related U.S. Application Data
(60) Provisional application No. 60/278,228, filed on Mar. 23, 2001.

(51) Int. Cl. G01N 21/77

(52) U.S. Cl. 436/169; 436/164; 544/274

(57) ABSTRACT

A caffeine detector comprises a reaction medium and a reagent impregnated in at least a portion of the reaction medium. The reagent provides the reaction medium with a color which is changed when a liquid containing a threshold amount of caffeine reacts with the reagent.

### CROSS REFERENCE TO RELATED APPLICATIONS

This application claims the benefit of U.S. Provisional Patent Application No. 60/278,228 filed Mar. 23, 2001.

### FIELD AND BACKGROUND OF THE INVENTION

Caffeine, the most widely consumed drug in the world, is a stimulant. Commonly found in coffee, tea, soft drinks, chocolate, and a wide variety of over-the-counter medications, caffeine is legal to buy and is easily accessible.

Caffeine is a physically addictive drug. Like all stimulants, caffeine raises blood pressure and increases the user's risk for high blood pressure, heart disease, and other health problems. Its effects range from mild alertness to heightened anxiety and body tension. In moderate doses it can produce “coffee nerves”, throbbing headaches, disorientation, depression, and insomnia.

Some regular users who stop consuming caffeine may experience withdrawal symptoms including drowsiness, headache, irritability, nausea and vomiting, and depression.

Caffeine is found in a variety of soft drinks, tea and coffee. According to the National Soft drink Association, Coca-Cola (regular and diet) contains 45.6 mg. of caffeine while Pepsi has 37.2 mg. per 12 ounce can.

By comparison, a 7 ounce cup of coffee has the following amounts of caffeine, according to Bunker and McWilliams in the Journal of the American Diet 74:28-32, 19979.

| | | |
|---|---|---|
| 1. | Drip | 115-175 mg. |
| 2. | Espresso | 100 mg. |
| 3. | Brewed | 80-135 mg. |
| 4. | Instant | 65-100 mg. |
| 5. | Decaf, brewed | 3-4 mg. |
| 6. | Decaf, instant | 2-3 mg. |
| 7. | Tea, iced (12 oz.) | 70 mg. |
| 8. | Tea, brewed, imported | 60 mg. |
| 9. | Tea, U.S. | 40 mg. |
| 10. | Tea, instant | 30 mg. |

The variability in the amount of caffeine in a cup of coffee or tea is relatively great even if prepared by the same person using the same equipment and ingredients day after day.

Description of Caffeine

Caffeine is known medically as trimethylxanthine, and the chemical formula is C₈H₁₀N₄O₂. When isolated in pure form, caffeine is a white crystalline powder that tastes very bitter. The chief source of pure caffeine is from the process of decaffeinating tea and coffee.

Medically, caffeine may be used as a cardiac stimulant and also as a mild diuretic. Recreationally, it is used to provide a “boost of energy” or a feeling of heightened alertness. It is often used to stay awake longer; college students and long distance drivers use it to stay awake late into the night. Many people feel as though they “cannot function” in the morning without their first cup of coffee for the caffeine and the boost that it provides to them.

Caffeine is an addictive drug. Among its actions, it operates using the same mechanisms that amphetamines, cocaine and heroin use to stimulate the brain. On a spectrum, caffeine's effects are more mild than amphetamines, cocaine and heroin, but it is manipulating the same channels and that is one of the issues that gives caffeine its addictive qualities. If one cannot function without caffeine and must consume it daily, one is, by definition, addicted to it.

Adenosine, a chemical created within the brain, binds normally to adenosine receptors. The binding of adenosine causes drowsiness by slowing down nerve cell activity. In the brain, adenosine binding also causes blood vessels to dilate (presumably to allow more oxygen to be present during sleep).

Caffeine simulates adenosine to a nerve cell. Caffeine therefore binds to the adenosine receptors. Caffeine, however, does not result in a reduction of nerve cell activity as adenosine would. Since the caffeine is binding with all of the receptors that are normally available to adenosine, the cell activity increases. Another response of the caffeine is indicated by the constriction of the brain's blood vessels as an antagonist to adenosine. This is the principle of using caffeine to treat vascular headaches, such as migraine.

The pituitary gland experiences the increased cellular activity and interprets this as a state of urgency causing the release of hormones stimulating the secretion of adrenal hormones in the form of adrenaline or epinephrine. This results in pupillary dilatation, bronchodilatation, tachycardia, superficial vascular constriction with shunting of blood to the skeletal musculature with an increase of blood pressure, slowing of visceral perfusion, hyperglycemia, and muscular contraction.

Caffeine also increases the dopamine levels in the same way that amphetamines do. Dopamine is a neurotransmitter that, in certain parts of the brain, activates the pleasure center. It is suspected that the dopamine connection contributes to caffeine addiction.

In summary one might understand why the body desires caffeine, especially if it is in need of sleep and needs to remain alert. Caffeine blocks adenosine reception resulting in alertness. It stimulates adrenaline secretion in to the system to give a “boost”. And it manipulates dopamine production to give a feeling of well being.

The problem with caffeine is, however, the long-term effects, which tend to spiral. Once the adrenaline dissipates, fatigue and depression return. The body is urged to consume more caffeine resulting in a state of irritability, once again producing a vicious cycle.

The most important long-term problem with caffeine is the effect that it has upon sleep. Adenosine reception is important to sleep, especially to deep sleep. The half-life of caffeine is about 6 hours. That means that if one consumes a large cup of coffee with 200 mg. of caffeine in it at 3:00 P.M., then by 9:00 P.M. about 100 mg. of caffeine will still be in the system. One may be able to fall asleep but the deep sleep will probably elude the body. The deficit is additive and the following day one will feel worse and the body will crave more caffeine. The cycle will continue day after day.

This is why 90% of the population consume caffeine each day. Once one gets in to the cycle, one craves more drug. Even worse, if one stops consuming caffeine, fatigue and depression returns and a vascular headache may manifest itself. These negative effects force resumption of the addiction in spite of the desire to quit.

Cardiovascular Effects of Caffeine

Caffeine consumption can be dangerous in some individuals. Those individuals have adverse cardiovascular sensitivities to the drug in the form of cardiac arrhythmias.

Normal sinus rhythm originates within the pacemaker cells of the sino-atrial node at the junction of the superior vena cava and the high right atrium of the heart. These cells represent the primary electrical generator (pacemaker) for the normal human heart. Conduction within the sinus node is slow, since it must occur through cells that are automatic and partially depolarized. The sinus node depolarizes at least 80 to 120 milliseconds before the start of the P wave on the ECG. Indirect human studies of the S-A (sino-atrial) conduction suggest it to be considerably longer than previously estimated and at least part of this conduction delay is due to specialized perinodal fibers surrounding the sinus node. The P wave is inscribed on the ECG as the electrical impulse spreads over the right and then the left atrium.

Any departure from a normal sinus heart rhythm is referred to as an arrhythmia.

Sinus tachycardia is a sinus rhythm in excess of 100 beats/minute in an adult. Caffeine will increase the heart rate. The patient may be aware of a fast rate and forceful contractions.

Atrial premature beats (APBs) or depolarizations may occur in normal hearts but are more often associated with heart disease, especially rheumatic and arteriosclerotic, and with conditions that tend to increase atrial and ventricle size and filing pressures. APBs are a common result of sympathomimetic drugs, tobacco, caffeine, and CNS disturbances.

Most patients that experience a skipped beat, flutter, or extra beats in the chest generally disregard them until their frequency causes alarm. Very early APBs may not allow sufficient ventricular filling to produce a palpable pulse.

In each case of cardiac arrhythmia, weakness, dizziness, cerebral anoxia, syncope, and syncope may result. The consumption of caffeine in these cases must be eliminated.

Effects of Caffeine upon Pregnancy

Caffeine has long been suspected of causing fetal abnormalities and reduction of fertility rates. These reports have proved controversial and data is scant but reduction of caffeine consumption in pregnant women would seem to be a prudent course.

A recent study has suggested a weak link between caffeine and sudden-infant-death-syndrome, as well. Abstinence is, therefore, recommended during pregnancy.

It has also been shown that caffeine reduces the rates of sperm motility in men, which might account for some findings of reduced fertility.

Caffeine and Osteoporosis (Calcium Loss)

A significant association between drinking caffeinated beverages and decreasing bone mineral density at both the hip and spine, independent of age, obesity, years since menopause, and the use of tobacco, estrogen, alcohol, thiazides, and calcium supplements, has been shown in women. Bone density did not, however, vary in women who reported drinking at least one glass of milk per day during most of their adult lives.

Gastro-Intestinal Effects of Caffeine

Gastric secretory studies may be useful to demonstrate achlorhydria or hypersecretion. Achlorhydria is diagnosed by the failure of gastric juice pH to fall below 6.5 with maximum stimulation. Gastric analysis is indicated where peptic ulcers recur frequently or respond poorly to treatment. Caffeine has been used as a stimulator of gastric acid secretion in these studies. It follows therefrom that individuals with a predisposition to gastric hypersecretion should avoid caffeine consumption.

### SUMMARY OF THE INVENTION

For all of the foregoing reasons, it would seem desirable to guarantee the absence of significant quantities of caffeine in the beverages consumed on a daily basis. One might assume that ordering a “decaffeinated” beverage in a restaurant or cafe would guarantee the appropriate result. It has been demonstrated, however, following publication in the lay print media and confirmed by video-magazine investigative reporting, that such an assumption is a fallacy.

According to one aspect of the invention, there is provided a caffeine detector comprising: a reaction medium; and a reagent impregnated in at least a portion of the reaction medium, the reagent providing the reaction medium with a color which is changed when a liquid containing a threshold amount of caffeine reacts with the reagent.

Preferably, the reaction medium is a filter paper strip, and the reagent comprises nitroblue tetrazolium (NBT). In one form, the reagent comprises a dry powder mixture comprising nitroblue tetrazolium (NBT), hydrogen peroxide, and a sulfate selected from copper sulfate (CuSO₄) and ferrous sulfate (Fe₂ (SO₄)₃)

In other embodiments, the reagent comprises orthophenylene diamine (OPD), nitroblue tetrazolium (NBT) and xanthine oxidase, and /or a superoxide dismutase.

The concentration of CuSO₄ or Fe₂ (SO₄)₃ and hydrogen peroxide may be varied to adjust the threshold amount of caffeine detected in the liquid. Further, the caffeine detector may comprise a plurality of filter paper strips formed into a book-like structure, and wherein a single filter paper strip can be removed when required for detecting caffeine.

According to another aspect of the invention, there is provided a method of detecting the presence of caffeine in a liquid, the method comprising: impregnating a reaction medium with a reagent which provides the reaction medium with a color which is changed when a liquid containing a threshold amount of caffeine reacts with the reagent; adding a liquid to the reaction medium so that it contacts and reacts with the reagent; and analyzing the reaction medium for any color change indicative of a threshold amount of caffeine in the liquid.

Preferably, the reaction medium is impregnated with a mixture comprising nitroblue tetrazolium (NBT), hydrogen peroxide, and a sulfate selected form the group consisting of copper sulfate (CuSO₄) and ferrous sulfate (Fe₂(SO₄)₃). The reaction medium is preferably a paper filter strip, and a plurality of paper filter strips may be formed into a book-like structure, and wherein a single paper filter strip can be removed therefrom when required to detect the presence of caffeine.

The method may further comprise the step of varying the concentration of CuSO₄ or Fe₂(SO₄)₃ and hydrogen peroxide to adjust the threshold amount of caffeine detected in the liquid.

One example of investigative reporting to the contrary of the expected result was the survey of local coffee shops, fast food restaurants, and conventional restaurants in the Twin Cities by Minneapolis, Minn. TV station, KARE 11. The hypothesis was to confirm if one really received decaf when ordered at these places of business.

Coffee was ordered at 12 establishments, taken to a local lab, and tested for caffeine content using a gas chromatography mass selection detector. This device was able to detect caffeine to a low-end level of 0.03 milligrams per ounce. All samples were from 6 ounce cups of coffee.

KARE 11 maintained that it used extraordinary control of the samples so as not to confuse those provided by the vendor. The results were varied but conclusive enough to confirm that there would be no guarantee the decaf would be served in over 50% of the cases when ordered at the table or counter.

According to one aspect of the invention, there is provided a method and a simple, disposable device for the rapid, safe, and non-toxic qualitative analysis of the level of caffeine in beverages, liquids or other foods. The present invention provides for a colorimetric disposable indicator device that differentiates between caffeinated and decaffeinated beverages that might be served upon request. This present invention provides an indicator which is intended to show confirmation of the absence or presence of caffeine content before consumption thus preventing the adverse effects noted above.

Chemistry and Design of the Analytical Device

The current technology for analysis of caffeine generally relates to an unnecessarily complex method and apparatus consisting of three sections and intended to be dipped into the beverage to be tested. The three sections are described as follows: 1) the dip section intended to be dipped into the beverage to be tested, 2) a temperature moderation section, and 3) the reagent section. While designed to avoid accidental contamination of the beverage, such contamination from the reagent section would remain a concern.

The current technology requires that the beverage to be tested be absorbed by means of “wicking” up and through the two adjacent sections while inserted in the beverage container to the reagent section before the appropriate chemical reaction can take place thus indicating the presence or absence of caffeine. This undesirably requires the beverage to be invaded within its container in order to be tested. The invasion furthermore requires a substantial period of time during which the beverage must travel up the two “wicking” sections and then be acted upon by the reagents before the indicating chemical reaction can take place. This device is not packaged in a disposable container and therefore is not discardable, biodegradable, or expendable.

According to another aspect of this invention, there is provided a disposable and biodegradable device for the testing of the presence or absence of caffeine in a beverage. The testing device is, in one embodiment, in the form of a reagent impregnated paper strip upon which a small amount, such as a drop from a spoon-full of beverage, is placed. An substantially instantaneous chemical reaction takes place indicating the presence or absence of caffeine in the tested beverage sample by means of a colorimetric change. The impregnated paper strips in one embodiment might be conveniently stapled within a flip-top matchbook-like enclosure to be torn out at will and disposed of following the testing procedure. However, the indicator paper strips may be packaged in other forms, as well.

The qualitative analysis of caffeine in a beverage to be tested is to be performed, according to one embodiment of the invention, as described below.

A reagent impregnated filter paper strip, such as, for example, one that is torn from the “matchbook” cover, is placed upon a dry, clean coffee cup saucer. The beverage of regard, e.g. coffee, is spooned from the containing cup and a drop is placed upon the filter paper strip. The chemical reaction takes place substantially instantaneously. The appearance or absence of a color change on the filter paper will provide the appropriate indication of the presence or absence of caffeine within the sample.

Detection of caffeine based on its antioxidant property: In the Fenton type reactions, H202 is dismutated into H20 and 02, using a metal cation such as Cu, Fe and Zn, as a catalyst. During this process, oxygen free radicals are generated. Caffeine can function as an antioxidant. In a reaction which uses a metal cation such as Cu in CuSO4 as catalyst, H202, in the form of urea hydrogen peroxide (solid) can be converted into H20 and 02, and oxygen free radicals are produced. The generation of 02 and oxygen free radicals are directly related. Presence of Caffeine in this reaction can reduce the level of oxygen free radicals that are present in the reaction, by acting as an antioxidant. The reduction of oxygen free radicals results in the reduction of 02. Hence, the presence of caffeine can reduce the level of 02 in the reaction. A reagent which can detect generated 02 (such as OPD) by color change (it will turn red after being oxidized), can be used as a way to measure the level of oxygen free radicals in the reaction in an indirect way. Hence the level of caffeine can be measured based on the degree of the color change in the reagent (OPD). The higher the level of caffeine, the lower the level of oxygen free radicals present in the reaction. The lower levels of oxygen free radicals, results in the lower levels of generated 02. The lower levels of generated 02 results in the less color change in OPD. The lower levels of caffeine in solution results in a sequence of events in an opposite direction, which results in the more color change in OPD. This can be used as a basis for the detection and measurement of caffeine in solution.

In accordance with the invention, several chemical reactive systems might be employed to indicate the presence or absence of caffeine within the beverage to be tested. These assays for the detection of caffeine are described below.

(A) Detection of Caffeine Based upon its Antioxidant Property

Reaction between CuSO₄ or Fe₂(SO₄)₃ and H₂O₂ results in the formation of oxygen free radicals. Nitroblue tetrazolium (NBT) is used as a reagent for the detection of oxygen free radicals. NBT is soluble in an aqueous media and has a very light yellow color. Reduction of the NBT by oxygen free radicals results in a formazine form of NBT, which is dark blue and insoluble. A dry powder mixture of CuSO₄ or Fe₂(SO₄)₃, urea hydrogen peroxide and NBT can be prepared and embedded into a filter paper. Addition of any aqueous media can start the reaction and the end result will be the appearance of a dark blue color on the paper. Caffeine can function as an antioxidant and can inhibit the reduction of NBT by oxygen free radicals. Hence, the lack of blue color (reduced NBT) can be used as an indicator for the presence of caffeine.

NBT might be replaced by orthophenylene diamine (OPD) which will result in a green indicator.

(B) Detection of Caffeine Based upon its Reaction with Xanthine Oxidase

Caffeine, a purine, can react with xanthine oxidase. The end products are uric acid and oxygen free radicals. Presence of oxygen free radicals can be detected by NBT as above. In this system, the solid phase (i.e. filter paper disc) can be coupled with xanthine oxidase and imbedded with NBT powder. Addition of caffeine in a solution can start the reaction and result in the reduction of NBT and the appearance of a dark blue color.

In each chemical assay for the concentration of caffeine in a beverage, the sensitivity of the assay is adjusted to detect the threshold level of caffeine in the beverage of regard. For example, brewed decaffeinated coffee contains 3 to 4 mg. of caffeine per 7 ounce cup and instant decaffeinated coffee contains 2 to 3 mg. of caffeine per 7 ounce of coffee. Brewed and instant coffee has a concentration of caffeine per 7 ounce cup of 65 to 135 mg.

The assay to detect the threshold concentration of caffeine, therefore, requires a detection system that indicates, in the first case, the absence of a blue color on the filter paper strip and the appearance of a blue color in the second chemical system. The sensitivity of the system is adjusted merely by means of selecting the concentration of the reagents in the chemical reaction.

In the first assay, the concentration of CuSO₄ or Fe₂(SO₄)₃ and H₂O₂ is titrated to generate the concentration of oxygen free radicals that would be scavenged by the threshold amount of caffeine (functioning as an antioxidant) to be detected in the beverage.

In the second assay (the preferential system), it is the concentration of the reagent, xanthine oxidase, which is varied to detect the desired threshold amount of caffeine to be detected. This is directly indicated with the appearance of a blue color upon the filter paper strip.

By these methods, the desired minimum concentration of caffeine to be measured can be adjusted by simply adjusting the concentration of the critical reagents.

General Discussion

Chemical reactions take place due to the exchange and movement of electrons from one element or compound to another. Movement of electrons causes the ionic status of the participating elements or compounds to change. Therefore, the movement of electrons and change in ionic status of the elements or compounds in a reaction are interrelated in a chemical or biochemical reaction. In order to ionize an element or a compound, one has to apply sufficient energy to it. Application of energy results in the removal or addition of electron(s) from or to the involved elements or compounds outer orbitals. Application of energy can be in the form of heat pressure, addition of a reactive element or compound, or dissolving in a solvent. Hence, in the reaction of A+B→C+D, where both A and B are solids, the reaction will not proceed simply by physical mixing of A and B. As mentioned above, there needs to be an application of energy to the A and B mixture to cause the reaction to proceed. For example, this energy could be provided by dissolving the A and B mixture in a solvent, such as water.

Under the conventional condition, to react A and B, one would prepare a solution of A and a solution of B and mix the two solutions to obtain the desired reaction. However, as pointed out above, the physical mixture of A and B will not produce any chemical or biochemical reactions so long as there is no energy applied (for example in the form of a solvent such as water). Therefore, the solid and dry mixture of A and B can be stored for a long time without any resulting reactions. The reaction between A and B can be started at any desired time, by application of energy (such as dissolving in water). This dry chemistry approach can cut down on the cost of reagents prepared for a chemical or biochemical assay. Reduction in cost will be in the following forms: 1) reduction in the cost of labor for preparation of individual solutions, 2) reduction in the cost of storage of the individual solutions (storage in cold or in bottles or in dark place), 3) reduction in the cost of scrapped reagents (since the dry solid mixture has shelf life of several years, it has no expiration date. Hence, it can be used at any time).

Redox reactions can be used as the basis for several kinds of assays. For example, the basis of redox reactions can be used for the detection of food preservatives, caffeine, food additives and vitamins. It can also be used for detection of toxicological and pharmaceutical compounds. This is due to the fact that majority of the above mentioned compounds function by oxidizing or reducing a factor. Hence, use of these compounds as an inhibitor or stimulator in a redox reaction can be the basis for variety of different assays. For example, variation of the basic Fenton type reactions (i.e. H202 +metal cation, such as Cu, Ca, Fe, Mg, etc. →H20 and 02) can be used to detect different types of food preservatives, caffeine, vitamin C and E, and pharmaceuticals. The level of sensitivity of these assays can be adjusted by inclusion of a factor, which enhances the redox reaction or inhibits it, depending on the condition of the assay. As an example, in an assay for the detection of caffeine, using Cu, H202 and o-phenylenediamine (OPD), where caffeine might act as an inhibitor by competing with OPD, one can increase the sensitivity of the assay by inclusion of superoxide dismutase (SOD). SOD scavenges oxygen anions produced in the reaction and hence inhibits it. Since the detection of caffeine is based on its inhibitory effect, addition of SOD to the mixture can increase the sensitivity of the assay. In another example, nitroblue tetrazolium (NBT) can be used for the detection of vitamin C. Vitamin C can reduce the NBT and result in a dark blue color.

NBT can also be reduced by riboflavin, after exposure to light. In this system, addition of riboflavin can increase the sensitivity of the assay. Also, a system like this could be used for the detection of either vitamin C or riboflavin. The concepts of dry chemistry could be applied to a redox system.

ELISA systems can be used for a variety of assays. Due to the fact that either the detecting antibody or antigen needs to be coupled to a solid matrix, this system is very well suited for the dry chemistry condition. Dry chemistry is particularly useful in this system because it can reduce the number of steps involved in the assay as well as the cost of production of reagents needed for the assay.

1. A caffeine detector comprising:
a reaction medium;
a reagent impregnated in at least a portion of the reaction medium, the reagent providing the reaction medium with a color which is changed when a liquid containing a threshold amount of caffeine reacts with the reagent.

2. A caffeine detector as claimed in claim 1 wherein the reaction medium is a filter paper strip.

3. A caffeine detector as claimed in claim 1 wherein the reagent comprises nitroblue tetrazolium (NBT).

4. A caffeine detector as claimed in claim 1 wherein the reagent comprises a dry powder mixture comprising nitroblue tetrazolium (NBT), hydrogen peroxide, and a sulfate.

5. A caffeine detector as claimed in claim 4 wherein the sulfate is selected from the group consisting of copper sulfate (CuSO₄, and ferrous sulfate (Fe₂(SO₄)₃).

6. A caffeine detector as claimed in claim 1 wherein the reagent comprises orthophenylene diamine (OPD).

7. A caffeine detector as claimed in claim 5 wherein the concentration of CuSO₄ or Fe₂(SO₄)₃ and hydrogen peroxide is varied to adjust the threshold amount of caffeine detected in the liquid.

8. A caffeine detector as claimed in claim 1 wherein the reagent comprises nitroblue tetrazolium (NBT) and xanthine oxidase.

9. A caffeine detector as claimed in claim 1 wherein the liquid is a beverage.

10. A caffeine detector as claimed in claim 9 wherein the beverage is selected from the group consisting of coffee, tea, sodas and juices.

11. A caffeine detector as claimed in claim 1 wherein the reagent comprises a superoxide dismutase.

12. A caffeine detector as claimed in claim 2 wherein a plurality of filter paper strips are formed into a book-like structure, and wherein a single filter paper strip can be removed when required for detecting caffeine.

13. A method of detecting the presence of caffeine in a liquid, the method comprising:
impregnating a reaction medium with a reagent which provides the reaction medium with a color which is changed when a liquid containing a threshold amount of caffeine reacts with the reagent;
adding a liquid to the reaction medium so that it contacts and reacts with the reagent;
analyzing the reaction medium for any color change indicative of a threshold amount of caffeine in the liquid.

14. A method as claimed in claim 13 wherein the reaction medium is impregnated with a mixture comprising nitroblue tetrazolium (NBT), hydrogen peroxide, and a sulfate selected form the group consisting of copper sulfate (CuSO₄) and ferrous sulfate (Fe₂(SO₄)₃).

15. A method as claimed in claim 13 wherein the reaction medium is impregnated with a mixture comprising nitroblue tetrazolium (NBT) and xanthine oxidase.

16. A method as claimed in claim 13 wherein the reaction medium is a paper filter strip.

17. A method as claimed in claim 16 further comprising the step of forming a plurality of paper filter strips into a book-like structure, and wherein a single paper filter strip can be removed therefrom when required to detect the presence of caffeine.

18. A method as claimed in claim 14 further comprising the step of varying the concentration of CuSO₄ or Fe₂(SO₄)₃ and hydrogen peroxide to adjust the threshold amount of caffeine detected in the liquid.
